(19) United States
(12) Patent Application Publication
(10) Pub. No.: US 2025/0202151 A1
(43) Pub. Date: Jun. 19, 2025

(54) CONNECTOR

(71) Applicant: SUMITOMO WIRING SYSTEMS, LTD., Mie (JP)

(72) Inventor: Taiga KADOYAMA, Mie (JP)

(21) Appl. No.: 18/966,860

(22) Filed: Dec. 3, 2024

(30) Foreign Application Priority Data
Dec. 13, 2023 (JP) 2023-210144

(51) Int. Cl. H01R 13/436

(52) U.S. Cl. CPC H01R 13/4364

(57) ABSTRACT

A connector of the present disclosure is provided with a plurality of types of terminals disposed side by side in a first direction, a housing including a plurality of cavities for respectively accommodating the plurality of types of terminals, the terminals being inserted into the cavities in a second direction intersecting the first direction, and a retainer to be mounted into the housing from a side opposite to the terminals in the second direction. An inner wall of the cavity is formed with a pair of locking lances disposed side by side in the first direction. The plurality of types of terminals includes at least one elliptical terminal having an elliptical shape in a front view. The elliptical terminal is formed with a pair of locked portions for holding the elliptical terminal by being respectively locked by the pair of locking lances.

### CROSS-REFERENCE TO RELATED APPLICATIONS

This application is based on and claims priority from Japanese Patent Application No. 2023-210144, filed on Dec. 13, 2023, with the Japan Patent Office, the disclosure of which is incorporated herein in its entirety by reference.

### TECHNICAL FIELD

The present disclosure relates to a connector.

### BACKGROUND

A connector described in Japanese Patent Laid-open Publication No. 2001-110500 is known as a connector in which the rattling of a terminal fitting in a cavity is suppressed. This connector is provided with a female terminal fitting, a connector housing including a cavity for accommodating the female terminal fitting and a retainer to be mounted on the front end of the connector housing. The connector housing includes a locking lance for locking the terminal fitting from behind. The retainer includes a pressing contact portion for pressing the terminal fitting against the ceiling wall of the cavity by coming into contact with the lower surface of the terminal fitting. If the terminal fitting is inserted into the cavity, the terminal fitting is primarily locked by the locking lance. If the retainer is mounted on the connector housing, a restricting piece provided in the retainer enters a deflection space for the locking lance and the deflection and deformation of the locking lance are restricted, whereby the terminal fitting is doubly locked in a retained state. Since the terminal fitting is pressed against the ceiling wall of the cavity by the pressing contact portion in this state, the rattling of the terminal fitting in a vertical direction is suppressed.

### SUMMARY

Since the connector housing and the retainer are separate components and a tolerance for assembling these is necessary, rattling corresponding to this tolerance is allowed. Therefore, it is difficult to suppress the terminal fitting from rattling in the vertical direction even if the pressing contact portion is provided in the retainer.

The present disclosure is directed to a connector with a plurality of types of terminals disposed side by side in a first direction, a housing including a plurality of cavities for respectively accommodating the plurality of types of terminals, the terminals being inserted into the cavities in a second direction intersecting the first direction, and a retainer to be mounted into the housing from a side opposite to the terminals in the second direction, an inner wall of the cavity being formed with a pair of locking lances disposed side by side in the first direction, the plurality of types of terminals including at least one elliptical terminal having an elliptical shape in a front view, the elliptical terminal being formed with a pair of locked portions for holding the elliptical terminal by being respectively locked by the pair of locking lances, the pair of locking lances being deflectable in the first direction, and the retainer including a pair of deflection suppressing portions for respectively suppressing deflection of the pair of locking lances by entering deflection spaces for the pair of locking lances and a pair of contact walls for contacting the elliptical terminal from both sides in the first direction.

According to the present disclosure, it is possible to suppress the rattling of a terminal in a cavity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a female connector of an embodiment when viewed obliquely from front.

FIG. 2 is a front view of the female connector when viewed from front.

FIG. 3 is a perspective view of the female connector when viewed obliquely from behind.

FIG. 4 is an exploded perspective view of the female connector.

FIG. 5 is a perspective view of an elliptical terminal when viewed obliquely from front.

FIG. 6 is a front view of the elliptical terminal when viewed from front.

FIG. 7 is a section along A-A of FIG. 2.

FIG. 8 is a section along A-A of FIG. 2 showing a state where a retainer is at a temporary locking position.

FIG. 9 is a section showing a state of inserting a releasing jig into a jig insertion hole.

FIG. 10 is a section showing a state where arcuate surfaces of the elliptical terminal are in contact with curved surfaces.

FIG. 11 is a perspective view of the retainer.

FIG. 12 is a perspective view of a housing.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Embodiments of the present disclosure are first listed and described.

[1] The connector of the present disclosure is provided with a plurality of types of terminals disposed side by side in a first direction, a housing including a plurality of cavities for respectively accommodating the plurality of types of terminals, the terminals being inserted into the cavities in a second direction intersecting the first direction, and a retainer to be mounted into the housing from a side opposite to the terminals in the second direction, an inner wall of the cavity being formed with a pair of locking lances disposed side by side in the first direction, the plurality of types of terminals including at least one elliptical terminal having an elliptical shape in a front view, the elliptical terminal being formed with a pair of locked portions for holding the elliptical terminal by being respectively locked by the pair of locking lances, the pair of locking lances being deflectable in the first direction, and the retainer including a pair of deflection suppressing portions for respectively suppressing deflection of the pair of locking lances by entering deflection spaces for the pair of locking lances and a pair of contact walls for contacting the elliptical terminal from both sides in the first direction.

According to this configuration, the pair of contact walls contact the elliptical terminal from the both sides in the first direction, whereby the elliptical terminal is prevented from moving in the first direction. Since the retainer is provided with the pair of contact walls, the rattling of the elliptical terminal in the cavity can be suppressed by providing the pair of contact walls in accordance with a dimension in the first direction of the elliptical terminal, regardless of a tolerance for assembling the retainer with the housing.

[2] Preferably, in [1] described above, the pair of contact walls are respectively formed with a jig insertion hole, a releasing jig for releasing locking of the locking lance being inserted into the jig insertion hole, and inner walls of a pair of the jig insertion holes are respectively formed with an inclined surface approaching the elliptical terminal as the releasing jig is inserted deeper.

By doing so, when the releasing jig is inserted into the jig insertion hole, an inserting operation of the releasing jig can be guided and the tip of the releasing jig is easily inserted between the locking lance and the locked portion by moving the tip of the releasing jig along the inclined surface.

[3] Preferably, in [1] or [2] described above, the elliptical terminal has a pair of arcuate surfaces located on both end parts in the first direction, the contact wall has a curved surface formed along the arcuate surface, and the curved surface contacts the arcuate surface in the first direction and a third direction intersecting both the first direction and the second direction.

By doing so, the curved surface of each contact wall contacts the arcuate surface of the elliptical terminal, whereby the elliptical terminal can be suppressed from moving in the first direction and the third direction intersecting both the first direction and the second direction.

[4] Preferably, in any one of [1] to [3] described above, a tip part of the deflection suppressing portion is formed with a tapered tip surface located more away from the elliptical terminal toward a tip.

By doing so, when the retainer is mounted into the housing, the tapered tip surface moves along the end part of the locking lance, whereby the deflection suppressing portion is easily guided into the deflection space for the locking lance.

[5] Preferably, in [2] described above, the locking lance is formed with a locking portion for locking the locked portion, an outer guiding wall for guiding the contact wall to a side opposite to the locking portion and an inner guiding wall for guiding the releasing jig toward the locking portion.

By doing so, the tip of each deflection suppressing portion moves along the outer guiding wall, whereby each deflection suppressing portion is guided into the deflection space for each locking lance. Further, the tip of the releasing jig moves along the inner guiding wall, whereby the releasing jig is guided between the locking portion and the locked portion.

### DETAILS OF EMBODIMENT OF PRESENT DISCLOSURE

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each drawing. “Perpendicular” in this specification means not only strictly perpendicular, but also substantially perpendicular within a range in which functions and effects in this embodiment are achieved.

Further, “facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts.

### Embodiment

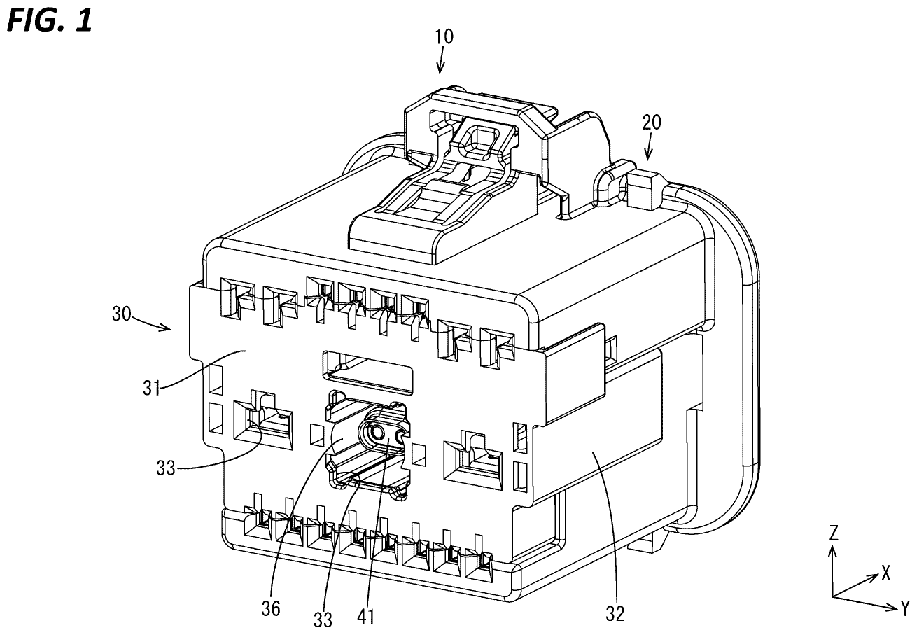

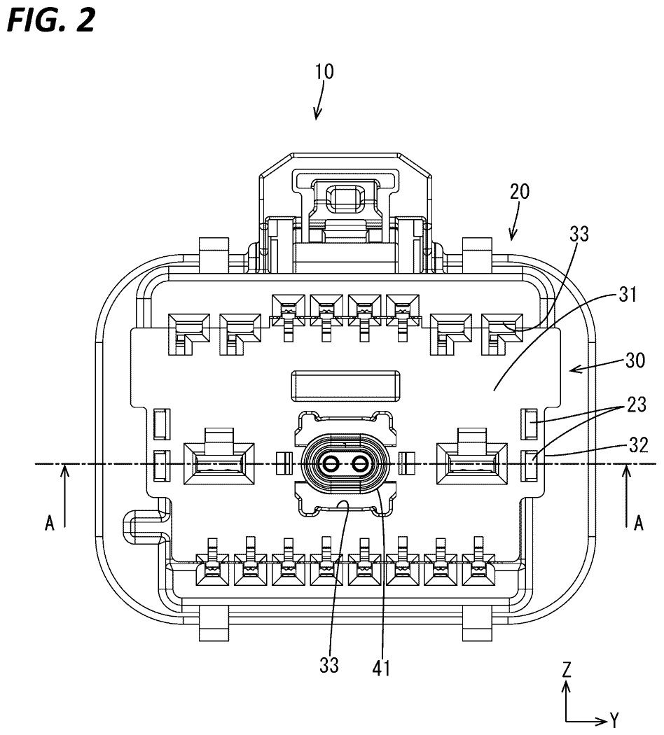

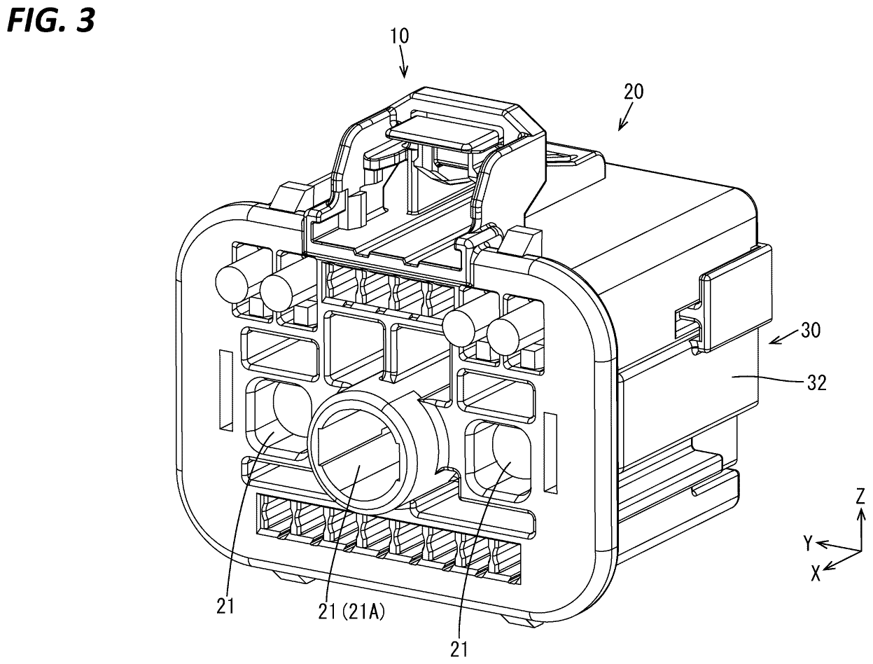

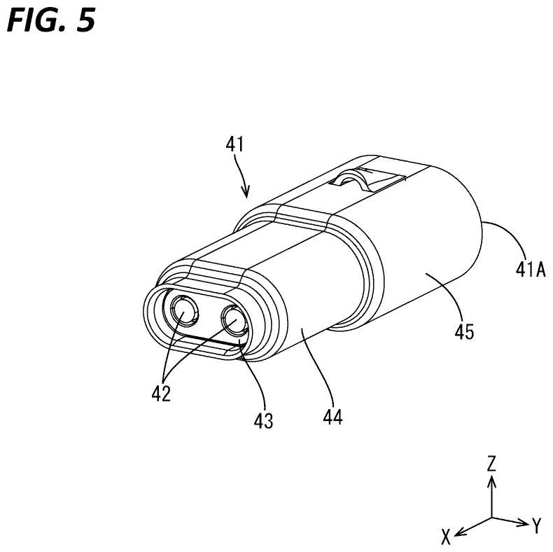

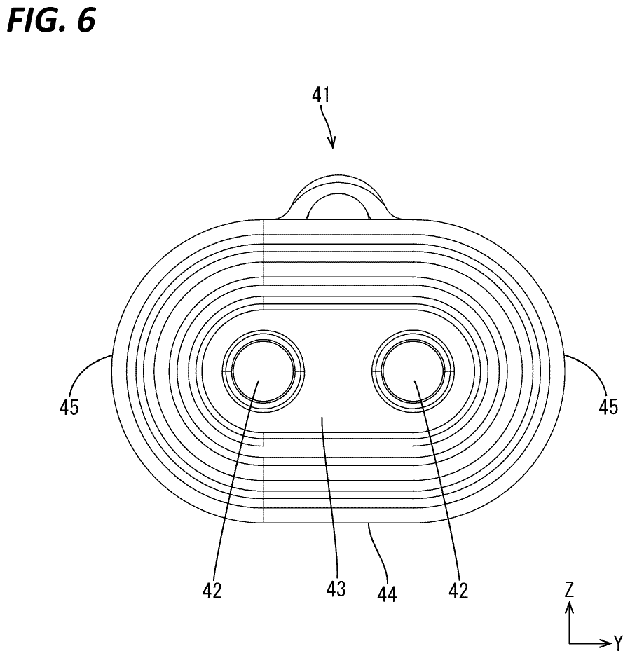

The embodiment of the present invention is described with reference to FIGS. 1 to 12. In the following description, a direction indicated by an arrow Z is referred to as an upward direction, a direction indicated by an arrow X is referred to as a forward direction and a direction indicated by an arrow Y is referred to as a leftward direction. A lateral direction is an example of a first direction. A front-rear direction is an example of a second direction. A vertical direction is an example of a third direction. Note that, for a plurality of identical members, only some members may be denoted by a reference sign and the other members may not be denoted by the reference sign.

### (Female Connector 10)

As shown in FIGS. 1 to 4, a female connector 10 is provided with a female housing 20 made of synthetic resin, a female retainer 30 made of synthetic resin and a plurality of types of terminals 40.

### (Terminals 40)

The plurality of types of terminals 40 include an elliptical terminal 41 having an elliptical shape in a front view, a pair of large-size female terminals 51 located on both left and right sides of the elliptical terminal 41, a plurality of small-size female terminals 52 located below the elliptical terminal 41 and the pair of large-size female terminals 51 and above the elliptical terminal 41, and a plurality of middle-size female terminals 53 located above the pair of large-size female terminals 51. The terminal 40 is formed by press-working a metal plate excellent in electrical conductivity. The sizes of the terminals 40 increase in the order of the small-size female terminals 52, the middle-size female terminals 53 and the large-size female terminals 51. Since being provided with the plurality of types of terminals 40, the female connector 10 may be called a hybrid connector.

Each female terminal 51, 52, 53 is provided with a connecting portion 51A, 52A, 53A in the form of a rectangular tube penetrating in the front-rear direction and a barrel portion 51B, 52B, 53B disposed therebehind. A resiliently deformable contact piece (not shown) is provided inside the connecting portion 51A, 52A, 53A, and each female terminal 51, 52, 53 is electrically connected to an unillustrated male terminal by this contact piece resiliently contacting the male terminal. The barrel portion 51B, 52B, 53B includes barrel pieces, and the barrel pieces are crimped to a core wire and a wire coating constituting a coated wire, whereby each female terminal 51, 52, 53 and each coated wire are electrically and mechanically connected.

The elliptical terminal 41 has a pair of arcuate surfaces 45 located on both end parts in the lateral direction. Further, the elliptical terminal 41 is provided with a pair of tube terminals 42 connected to ends of a pair of cables for transmitting differential signals, an insulating member 43 for holding the pair of tube terminals 42 and an electrically conductive shield member 44 surrounding the insulating member 43. A front stop protrusion for stopping the elliptical terminal 41 in front is formed to project upward on the upper surface of the shield member 44. The arcuate surfaces 45 are formed on both end parts in the lateral direction in the shield member 44. The elliptical terminal 41 is used for a high-speed twisted pair cable, the female connector 10 may be called a HMTD (High-Speed Modular Twisted-Pair Data) connector.

### (Female Housing 20)

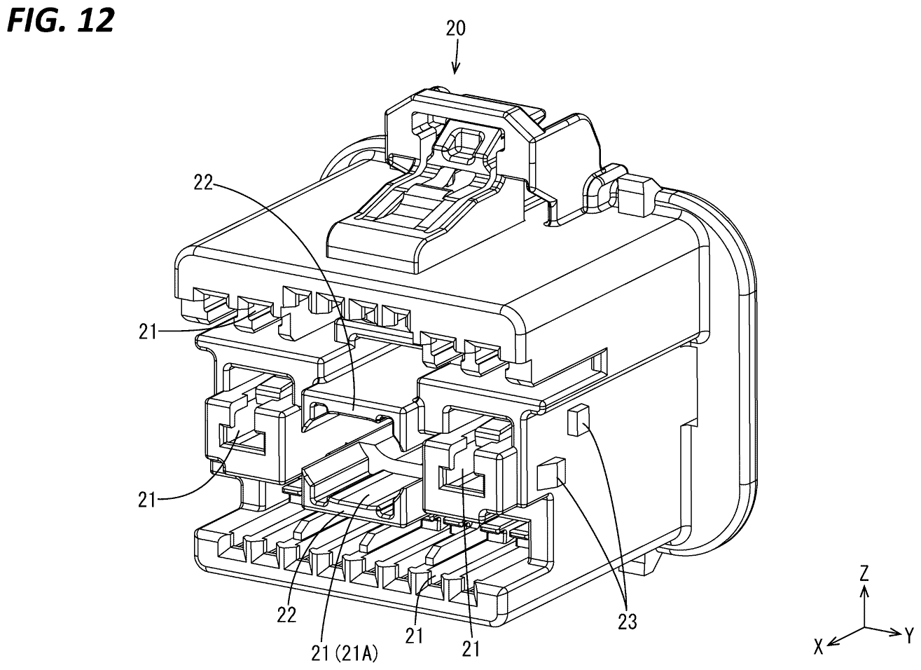

As shown in FIG. 12, the female housing 20 is substantially in the form of a rectangular block. A plurality of cavities 21 for accommodating the plurality of terminals 40 are formed inside the female housing 20. Out of the plurality of cavities 21, a cavity 21A for accommodating the elliptical terminal 41 is located in a centra part of the female housing 20 in a front view. The elliptical terminal 41 is inserted into the cavity 21A from behind.

The cavity 21A is formed between a pair of upper and lower terminal accommodation walls 22. The terminal accommodation walls 22 are formed along the upper and lower surfaces of the shield member 44 of the elliptical terminal 41 and the arcuate surfaces connected to the upper and lower surfaces on both sides. Therefore, the elliptical terminal 41 is suppressed from moving in the vertical direction and the lateral direction by the pair of terminal accommodation walls 22.

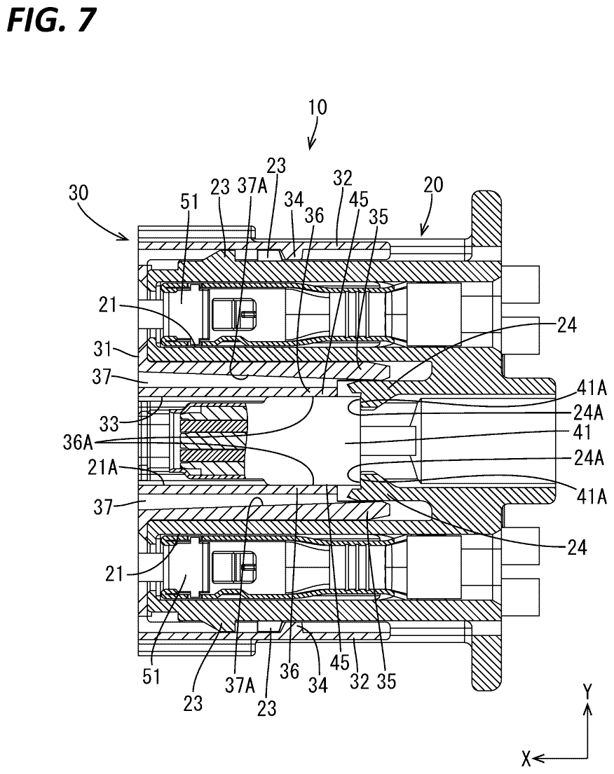

As shown in FIG. 7, a pair of left and right locking lances 24 are provided inside the cavity 21A. The locking lance 24 is cantilevered forward from an inner wall constituting the cavity 21A. The locking lance 24 is formed to be deflectable in the lateral direction. Locking portions 24A are respectively formed on facing surfaces of the pair of locking lances 24 facing each other. The elliptical terminal 41 is formed with a pair of locked portions 41A disposed side by side in the lateral direction and configured to hold the elliptical terminal 41 by being locked by the locking portions 24A of the pair of locking lances 24.

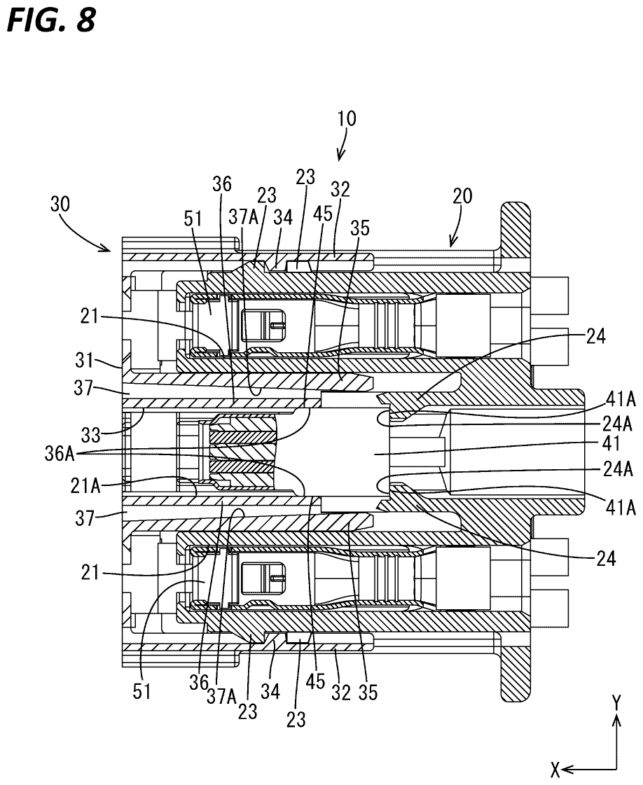

A pair of holding projections 23 are formed on each of both left and right side surfaces, out of the outer peripheral surface of the female housing 20. The female retainer 30 is movable between a temporary locking position (position of the female retainer 30 shown in FIG. 8) and a complete locking position (position of the female retainer 30 shown in FIG. 7) with respect to the female housing 20. The female retainer 30 can be held at each of the temporary locking position and the complete locking position by being locked by the pair of holding projections 23.

### (Female Retainer 30)

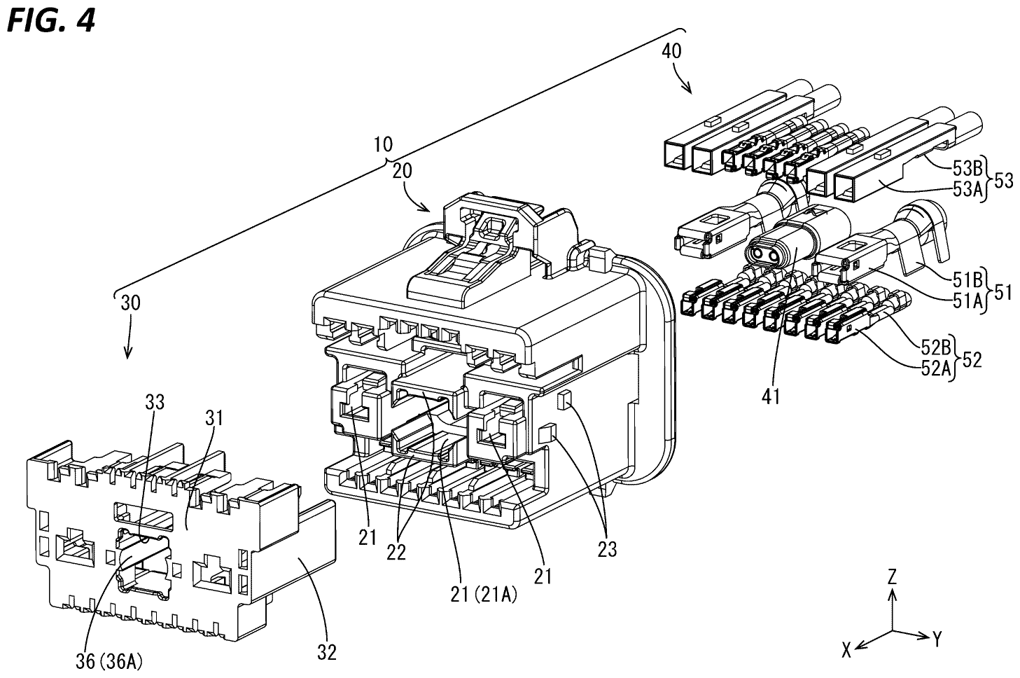

As shown in FIG. 4, the female retainer 30 is provided with a female retainer body 31 for constituting the front surface of the female housing 20, a pair of mounting portions 32 disposed on both left and right sides of the female retainer body 31 and a plurality of deflection suppressing portions 35 projecting rearward from the rear surface of the female retainer body 31. The female retainer body 31 includes a plurality of terminal insertion openings 33, through which the male terminals are introduced into the respective cavities 21. Since a mold is removed forward in molding the locking lances 24 of the female housing 20, the front surface of the female housing 20 cannot be formed at positions where mold removal holes are formed. Thus, the front surface of the female housing 20 is constituted by the female retainer body 31 of the female retainer 30.

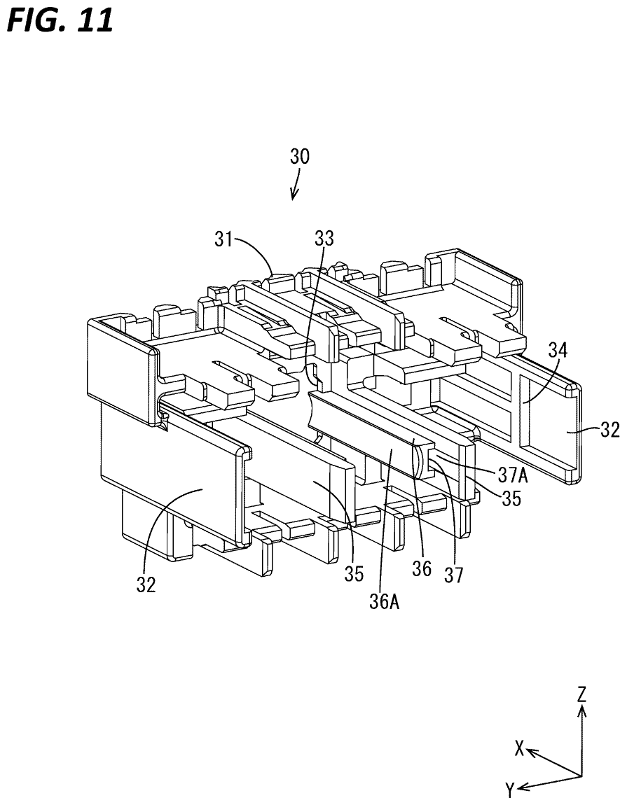

As shown in FIG. 11, mounting protrusions 34 extending in the vertical direction are respectively formed on facing surfaces of the pair of mounting portions 32 facing each other. At the temporary locking position, the front holding projections 23 shown in FIG. 12 are located in front of the mounting protrusions 34 and the rear holding projections 23 are located behind the mounting protrusions 34, whereby the female retainer 30 is held at the temporary locking position with a movement in the front-rear direction suppressed. At the complete locking position, both the front and rear holding projections 23 shown in FIG. 12 are located in front of the mounting protrusions 34, whereby the female retainer 30 is held at the complete locking position with a forward movement suppressed.

As shown in FIG. 11, a pair of the deflection suppressing portions 35 are formed on the rear surface of the female retainer body 31. The deflection suppressing portion 35 is formed to project rearward from the hole edge of the terminal insertion opening 33. The pair of deflection suppressing portions 35 are disposed to face each other in the lateral direction. A pair of contact walls 36 are formed to project in directions toward each other on facing surfaces of the pair of deflection suppressing portions 35 facing each other. The contact wall 36 is integrally formed to the deflection suppressing portion 35. Thus, the deflection suppressing portion 35 is also reinforced by the contact wall 36. The rear end of the contact wall 36 is located forward of the rear end of the deflection suppressing portion 35.

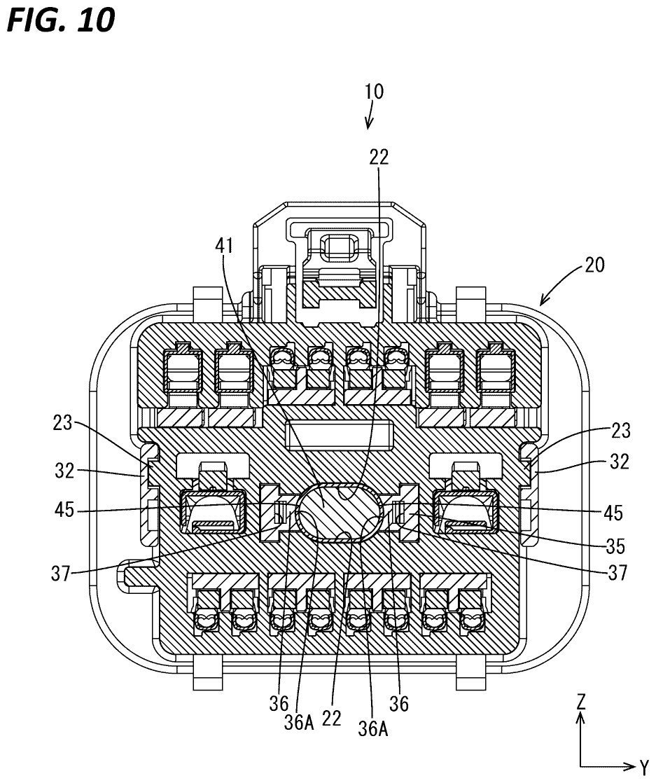

The contact wall 36 has a curved surface 36A formed along the arcuate surface 45 of the elliptical terminal 41. The curved surface 36A contacts the arcuate surface 45 substantially entirely. As shown in FIGS. 7 and 10, the pair of curved surfaces 36A are in contact with the pair of arcuate surfaces 45 at the complete locking position. The curved surface 36A is in contact with the arcuate surface 45 in the lateral direction and the vertical direction. Thus, the elliptical terminal 41 does not rattle in the lateral direction and does not fall down at the complete locking position. Further, since the pair of curved surfaces 36A are partially in contact with the pair of arcuate surfaces 45 also at the temporary locking position as shown in FIG. 8, the elliptical terminal 41 does not rattle in the lateral direction and does not fall down also at the temporary locking position.

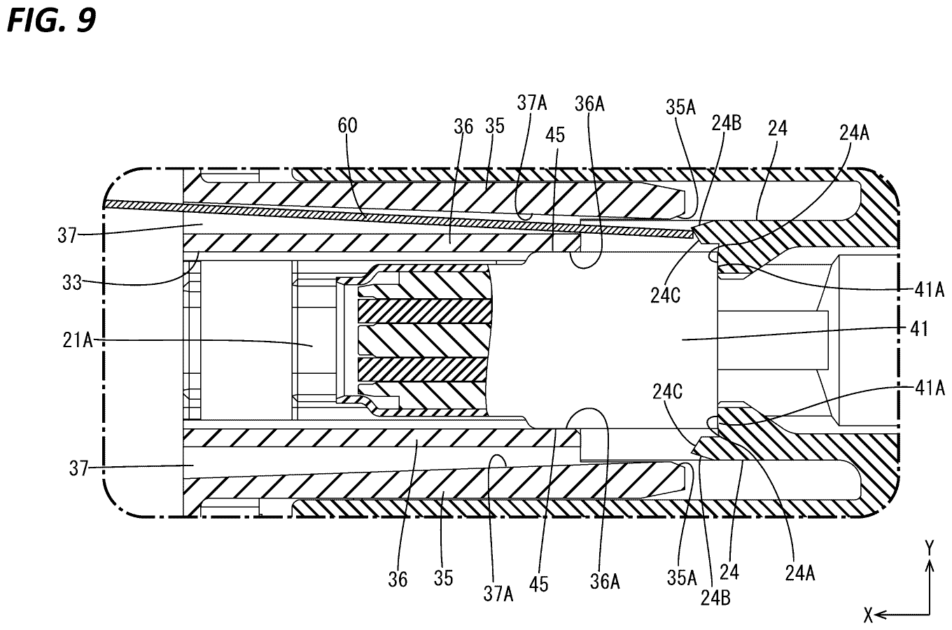

As described above, since the deflection suppressing portion 35 and the contact wall 36 are integrally formed, the deflection suppressing portion 35 is reinforced by the contact wall 36. A jig insertion hole 37 is formed at a position near the deflection suppressing portion 35 in the contact wall 36. The jig insertion hole 37 is formed to penetrate in the front-rear direction. As shown in FIG. 9, a releasing jig 60 is insertable into the jig insertion hole 37 from front.

An inclined surface 37A approaching the elliptical terminal 41 as the releasing jig 60 is inserted deeper is formed on the inner wall of the jig insertion hole 37. The inclined surface 37A is formed on a side wall on the side of the deflection suppressing portion 35, out of the inner wall of the jig insertion hole 37. If the tip of the releasing jig 60 is moved along the inclined surface 37A, the releasing jig 60 is guided into a proper insertion posture to approach the elliptical terminal 41. Thus, the releasing jig 60 can be smoothly inserted into the jig insertion hole 37. Note that, by coupling a pair of the releasing jigs 60 to be inserted into the pair of jig insertion holes 37 to configure a gate-shaped releasing jig, the releasing jigs 60 may be made more smoothly insertable into the jig insertion holes 37.

Since the deflection suppressing portions 35 are retracted from deflection spaces for the locking lances 24 at the temporary locking position, the tips of the deflection suppressing portions 35 may interfere with projecting end parts of the locking lances 24 when the female retainer 30 is pushed to the complete locking position. To avoid such a situation, tapered tip surfaces 35A located more away from the elliptical terminal 41 toward the tips are formed on tip parts of the deflection suppressing portions 35 as shown in FIG. 9. By doing so, when the female retainer 30 is pushed from the temporary locking position to the complete locking position, the tapered tip surfaces 35A move along the projecting end parts of the locking lances 24, whereby the deflection suppressing portions 35 can be smoothly guided into the deflection spaces for the locking lances 24.

The projecting end part of the locking lance 24 is formed with an outer guiding wall 24B for guiding the contact wall 36 outwardly of the locking lance 24 (toward a side away from the elliptical terminal 41) and an inner guiding wall 24C for guiding the releasing jig 60 inwardly of the locking lance 24 (toward the elliptical terminal 41). In other words, as shown in FIG. 9, the inner guiding wall 24C is disposed on the side of the elliptical terminal 41 and the outer guiding wall 24B is disposed on the side of the deflection space for the locking lance 24.

If the tip of the releasing jig 60 is guided inward while being held in contact with the inner guiding wall 24C, the tip of the releasing jig 60 is easily inserted between the locking portion 24A of the locking lance 24 and the locked portion 41A of the elliptical terminal 41. Therefore, the locking lance 24 is easily deflected outward and the locking of the locking portion 24A of the locking lance 24 and the locked portion 41A of the elliptical terminal 41 is easily released.

Further, if the tapered tip surfaces 35A of the deflection suppressing portions 35 are guided outward by being held in contact with the outer guiding walls 24B, the deflection suppressing portions 35 are easily inserted into the deflection spaces for the locking lances 24. If the deflection suppressing portions 35 enter the deflection spaces for the locking lances 24, the deflection of the locking lances 24 is suppressed, wherefore the elliptical terminal 41 is doubly locked by the locking lances 24 and the deflection suppressing portions 35.

### Functions and Effects of Embodiment

(1) The female connector 10 of the embodiment is provided with the plurality of types of terminals 40 disposed side by side in the lateral direction, the female housing 20 including the plurality of cavities 21 for respectively accommodating the plurality of types of terminals 40, the terminals 40 being inserted into the cavities 21 in the front-rear direction intersecting the lateral direction, and the female retainer 30 to be mounted into the female housing 20 from the side opposite to the terminals 40 in the front-rear direction, the inner wall of the cavity 21 is formed with the pair of locking lances 24 disposed side by side in the lateral direction, the plurality of types of terminals 40 include at least one elliptical terminal 41 having an elliptical shape in a front view, the elliptical terminal 41 is formed with the pair of locked portions 41A for holding the elliptical terminal 41 by being respectively locked by the pair of locking lances 24, the pair of locking lances 24 are deflectable in the lateral direction, and the female retainer 30 includes the pair of deflection suppressing portions 35 for respectively suppressing the deflection of the pair of locking lances 24 by entering the deflection spaces for the pair of locking lances 24 and the pair of contact walls 36 for contacting the elliptical terminal 41 from the both sides in the lateral direction.

According to this configuration, the pair of contact walls 36 contact the elliptical terminal 41 from the both sides in the lateral direction, whereby the elliptical terminal 41 is prevented from moving in the lateral direction. Since the pair of contact walls 36 are provided in the female retainer 30, the rattling of the elliptical terminal 41 in the cavity 21A can be suppressed by providing the pair of contact walls 36 in accordance with a lateral dimension of the elliptical terminal 41, regardless of a tolerance for assembling the female retainer 30 with the female housing 20.

(2) The pair of contact walls 36 are respectively formed with the jig insertion hole 37, into which the releasing jig 60 for releasing the locking of the locking lance 24 is inserted, and the inner walls of the pair of jig insertion holes 37 are respectively formed with the inclined surface 37A approaching the elliptical terminal 41 as the releasing jig 60 is inserted deeper.

By doing so, when the releasing jig 60 is inserted into the jig insertion hole 37, an inserting operation of the releasing jig 60 can be guided and the tip of the releasing jig 60 is easily inserted between the locking lance 24 and the locked portion 41A by moving the tip of the releasing jig 60 along the inclined surface 37A.

(3) Preferably, the elliptical terminal 41 has the pair of arcuate surfaces 45 located on the both end parts in the lateral direction, the contact wall 36 has the curved surface 36A formed along the arcuate surface 45, and the curved surface 36A contacts the arcuate surface 45 in the lateral direction and the vertical direction intersecting both the lateral direction and the front-rear direction.

By doing so, the curved surface 36A of each contact wall 36 contacts the arcuate surface 45 of the elliptical terminal 41, whereby the elliptical terminal 41 can be suppressed from moving in the lateral direction and the vertical direction intersecting both the lateral direction and the front-rear direction.

(4) Preferably, the tip part of the deflection suppressing portion 35 is formed with the tapered tip surface 35A located more away from the elliptical terminal 41 toward the tip.

By doing so, when the female retainer 30 is mounted into the female housing 20, the tapered tip surfaces 35A move along the end parts of the locking lances 24, whereby the deflection suppressing portions 35 are easily guided into the deflection spaces for the locking lances 24.

(5) Preferably, the locking lance 24 is formed with the locking portion 24A for locking the locked portion 41A, the outer guiding wall 24B for guiding the contact wall 36 toward the side opposite to the locking portion 24A and the inner guiding wall 24C for guiding the releasing jig 60 toward the locking portion 24A.

By doing so, the tip of each deflection suppressing portion 35 moves along the outer guiding wall 24B, whereby each deflection suppressing portion 35 is guided into the deflection space for each locking lance 24. Further, the tip of the releasing jig 60 moves along the inner guiding wall 24C, whereby the releasing jig 60 is guided between the locking portion 24A and the locked portion 41A.

### OTHER EMBODIMENTS

The above embodiment can be modified and carried out as follows. The above embodiment and the following modifications can be carried out in combination with each other without technically contradicting each other.
Although the female connector provided with the female terminals 40 has been illustrated as a connector in the above embodiment, the connector may be a male connector provided with male terminals.
Although the pair of contact walls 36 are in contact with the elliptical terminal 41 both at the temporary locking position and at the complete locking position in the above embodiment, the pair of contact walls may be in contact with the elliptical terminal only at the complete locking position.
Although the pair of locking lances 24 are disposed side by side in the lateral direction in the above embodiment, the pair of locking lances may be disposed side by side in the vertical direction.
Although the female retainer 30 is formed with the jig insertion holes 37 in the above embodiment, the female housing may be formed with the jig insertion holes.
Although the contact wall 36 has the arcuated curved surface 36A in the above embodiment, the contact wall may have a gate-shaped support surface.
Although both the tapered tip surface 35A and the outer guiding wall 24B are formed in the above embodiment, only either one of the tapered tip surface 35A and the outer guiding wall 24B may be formed.
Although both the inclined surface 37A and the inner guiding wall 24C are formed in the above embodiment, only either one of the inclined surface 37A and the inner guiding wall 24C may be formed.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a plurality of types of terminals disposed side by side in a first direction;
a housing including a plurality of cavities for respectively accommodating the plurality of types of terminals, the terminals being inserted into the cavities in a second direction intersecting the first direction; and
a retainer to be mounted into the housing from a side opposite to the terminals in the second direction,
an inner wall of the cavity being formed with a pair of locking lances disposed side by side in the first direction,
the plurality of types of terminals including at least one elliptical terminal having an elliptical shape in a front view,
the elliptical terminal being formed with a pair of locked portions for holding the elliptical terminal by being respectively locked by the pair of locking lances,
the pair of locking lances being deflectable in the first direction, and
the retainer including a pair of deflection suppressing portions for respectively suppressing deflection of the pair of locking lances by entering deflection spaces for the pair of locking lances and a pair of contact walls for contacting the elliptical terminal from both sides in the first direction.

2. The connector of claim 1, wherein the pair of contact walls are respectively formed with a jig insertion hole, a releasing jig for releasing locking of the locking lance being inserted into the jig insertion hole, and inner walls of a pair of the jig insertion holes are respectively formed with an inclined surface approaching the elliptical terminal as the releasing jig is inserted deeper.

3. The connector of claim 1, wherein:
the elliptical terminal has a pair of arcuate surfaces located on both end parts in the first direction,
the contact wall has a curved surface formed along the arcuate surface, and
the curved surface contacts the arcuate surface in the first direction and a third direction intersecting both the first direction and the second direction.

4. The connector of claim 1, wherein a tip part of the deflection suppressing portion is formed with a tapered tip surface located more away from the elliptical terminal toward a tip.

5. The connector of claim 2, wherein the locking lance is formed with a locking portion for locking the locked portion, an outer guiding wall for guiding the contact wall to a side opposite to the locking portion and an inner guiding wall for guiding the releasing jig toward the locking portion.
